(19) United States
(12) Patent Application Publication
(10) Pub. No.: US 2011/0095988 A1
(43) Pub. Date: Apr. 28, 2011

(54) Integrated control mechanism for handheld electronic devices

(76) Inventor: Tara Chand Singhal, Torrance, CA (US)

(21) Appl. No.: 12/589,487

(22) Filed: Oct. 24, 2009

(51) Int. Cl. G06F 3/041

(52) U.S. Cl. 345/173

(57) ABSTRACT

An integrated control mechanism integrates a touch sense control mechanism on the top and an electrical switch control mechanism underneath the touch sense control mechanism. The integrated control mechanism is operated by a thumb-tip touch action on surface of the touch sense control mechanism to operate the touch sense control mechanism and by thumb-tip pressure on the same touch sense control mechanism to operate the electrical switch control mechanism underneath. Using an integrated control mechanism operated by a human thumb-tip enables the human hand to hold handheld devices in the palm and fingers and the human thumb-tip via the integrated control mechanism to be able to operate various functions and operational modes of the handheld device. The integrated control mechanism may be used in many types of handheld electronic devices.

### CROSS REFERENCE TO RELATED APPLICATIONS

This application is related to and claims priority on U.S. application Ser. No. 12/454,345, titled “Apparatus and Method for Touch Screen User Interface for Handheld Devices Part I, filed May 15, 2009, by Tara Chand Singhal. The contents of U.S. application Ser. No. 12/454,345 are incorporated herein by reference.

### FIELD OF THE INVENTION

The embodiments described herein are for an integrated control mechanism for handheld electronic devices that integrates a touch screen user interface with an electrical switch for use in applications such as, remote controls, music devices, gaming devices, personal digital assistants, cameras, direction devices and mobile cell phones.

### BACKGROUND

Applicant's U.S. patent application Ser. No. 12/454,345, titled “Apparatus and Method for Touch Screen User Interface for Handheld Devices Part I, filed May 15, 2009, describes a device function control means for handheld electronic devices using touch screen control technology.

The handheld device uses have grown exponentially and these devices perform many more functions then they were originally used for. Also these handheld devices are limited in physical size. Hence even more versatile device function control means are needed that would be useful to perform a large range of control functions from control means that are situated within a small physical space.

The handheld devices have limited physical space for positioning control mechanisms and thus are in need for versatile control mechanisms that occupy limited space, can perform many functions, and are ergonomically easy to operate.

Hence, it is the objective of the embodiments described herein to have an improved user interface via a combination of many types of control means such as touch screen and electrical switch means in hand held electronic devices.

It is also the objective of the embodiments to have an improved device function control in such hand held devices.

### SUMMARY

A handheld electronic device has an integrated control mechanism that integrates a touch sense control mechanism on the top and an electrical switch control mechanism underneath the touch sense control mechanism. The integrated control mechanism is operated by a thumb-tip touch action on the surface of the touch sense control mechanism to operate the touch sense control mechanism and by thumb-tip pressure on the same touch sense control mechanism to operate the electrical switch control mechanism underneath.

Using an integrated control mechanism operated by a thumb-tip enables the hand to hold the handheld device in the palm and fingers and the thumb-tip to be able to control and operate various functions and operational modes of the handheld device. The preferred size of the touch surface of the touch sense control mechanism is in the range of ½× 1/2 inches to ¾ by ¾ inch and would afford the integrated control mechanism to be limited in size for the limited space available on the handheld for positioning such integrated control mechanism.

The handheld device that may have the integrated control mechanism may be a remote control for controlling remote devices via an infrared transmitting means in the handheld device, a cellular phone, a multi-purpose device that incorporates multiple features of cell phone, music device and camera, a music device, and a camera device.

The integrated control mechanism, it is believed, provides a compact, versatile, and more effective user interface in handheld electronic devices. These and other features of the embodiments would become clear with the help of the description and accompanying drawings.

### BRIEF DESCRIPTION OF THE DRAWINGS

Some of the novel features of the embodiments will be best understood from the accompanying drawings, taken in conjunction with the accompanying description, in which similar reference characters refer to similar parts, and in which:

FIG. 1 is a block diagram that illustrates features of an embodiment of a version of integrated control mechanism for user interface in handheld electronic devices.

FIG. 2 is a block diagram that illustrates hardware and interface features of the present embodiments of integrated control mechanism.

FIG. 3 is a block diagram that illustrates features of the present embodiments of a version of touch screen control mechanism.

FIG. 4 is a block diagram that illustrates various applications of features of the present embodiments of an integrated control mechanism.

### DESCRIPTION

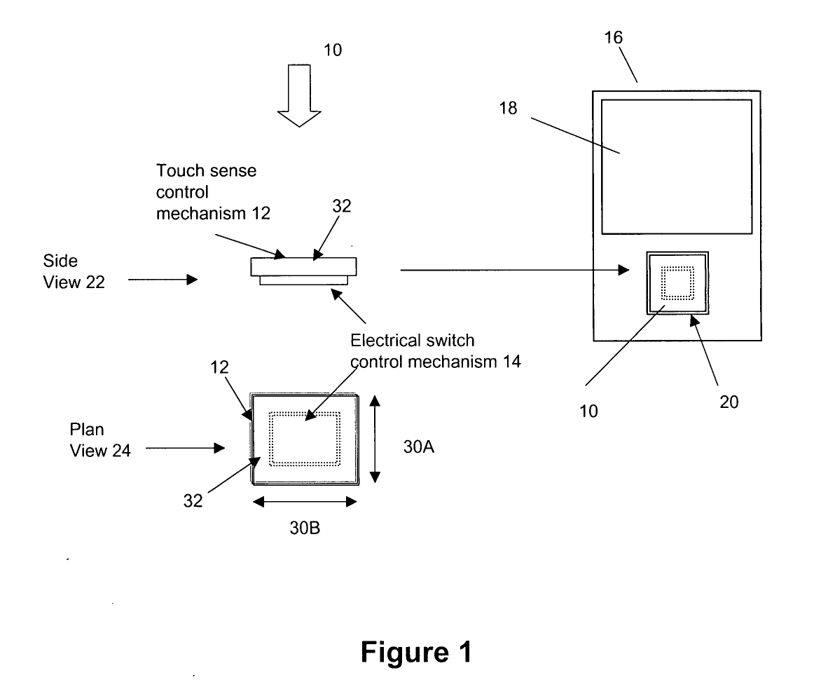

As illustrated in FIG. 1, a handheld electronic device 16 has a display screen 18 on a part of the device and an integrated control mechanism 10. The integrated control mechanism 10 integrates a touch sense control mechanism 12 on the top and an electrical switch control mechanism 14 underneath the touch sense control mechanism 12. The integrated control mechanism 10 is positioned on the handheld device 16 next to the display screen 18.

The integrated control mechanism 10 is shown with a side view 22 and plan view 24 that integrates a touch sense control mechanism 12 on the top and an electrical switch control mechanism 14 underneath the touch sense control mechanism 12. The integrated control mechanism 10 is incorporated in the handheld device 16 via an interface socket 20 in the handheld device 16 for control and operation of the functions of the handheld device 16.

The integrated control mechanism 10 is operated by a thumb-tip touch action on the touch surface 32 of the touch sense control mechanism 12 to operate the touch sense control mechanism 12 and by thumb-tip pressure on the same touch sense control mechanism 12 to operate the electrical switch control mechanism 14 underneath.

Using an integrated control mechanism 10 operated by a thumb-tip enables the hand to hold handheld device 16 in the palm and fingers and the thumb-tip via the integrated control mechanism 10 to be able to operate various functions and operational modes of the handheld device 16 as described later.

The touch sense control mechanism 12 has a touch sense surface 32 that is limited in surface size in one of its dimensions 30A or 30B to be a maximum of 1.0 inch and the surface area 30A times 30B is less than or equal to one square inch.

The preferred size of the touch surface 32 would be close to a ½×½ inches or ¾ by ¾ inch as that would afford the integrated control mechanism 10 to be limited in size for the limited space available on the handheld 16 for positioning such integrated control mechanism.

The touch sense control mechanism 12 has touch sense signal outputs that correspond to the touch sense for interface to an operational logic circuit of the handheld device 16 via interface socket 20. The electrical switch control mechanism 14 also has switch state signals for interface to an operational logic circuit of the hand held device 16 via interface socket 20.

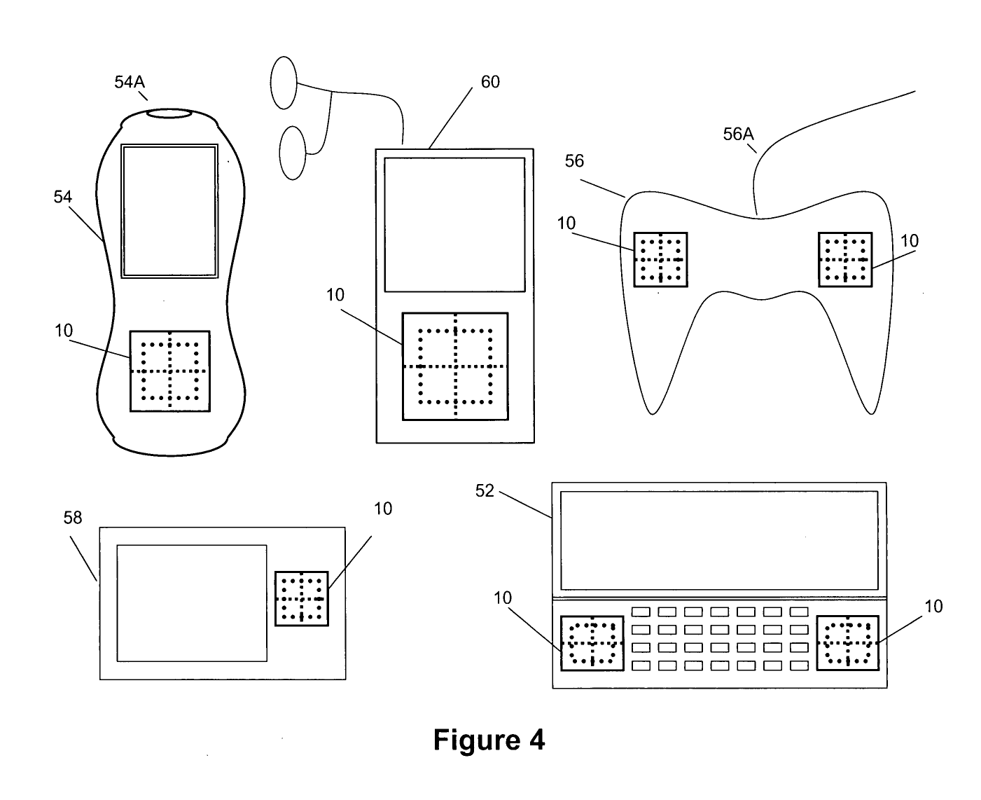

The integrated control mechanism 10 may be used in any number of handheld device applications. The integrated control mechanism may be used in handheld electronic devices that may include (i) remote control devices for controlling the functions of a television, digital recording device or a home theatre system, (ii) wireless communication devices such as cell phones, (iii) multi-purpose devices that provide many functions of communication, games, music and data storage, and (iv) game device applications. It may also be used for applications not specifically identified above. Some of these applications are illustrated later with reference to FIG. 4.

Hence, the handheld device 16 may be used for one of the applications from a group of applications of, (i) a remote control for controlling remote devices via a infrared transmitting means in the handheld device, (ii) a cellular phone, (iii) a multi-purpose device that incorporates multiple features of cell phone, music device and camera, (iii) a music device, (iv) and a camera device.

The touch sense control mechanism 12 may be used for navigation and function control of the software executed functions of the handheld device 16. These may include scrolling in both vertical and horizontal directions and an item or a function selection. The electrical switch control mechanism 14 may be used for other control functions of the handheld device 16. These other functions may include on/off power mode, transitions between standby and operational modes, phone pick up and hang up, mode selections between modes of menu, games, music, data, camera, or home.

The electrical switch control mechanism 14 with the help of the operational logic of the device 16 may support multiple control functions that are based on the length of the time the switch mechanism 14 is activated for. Also the sequence of switch activations may be used by the device 16's operational logic to distinguish from different functions of the handheld device 16.

As a simplified illustration, if the electrical switch control mechanism 14 is depressed for a second or less, it may support the control function of pick-up a phone connection and then a subsequent depression of the switch 14 also for a second or less may be used for hang-up the phone connection. If the switch 14 is activated for a time duration in the range of 2 to 3 seconds, the device 16 operational logic would equate that to a control function of transitioning the device 16 from a standby mode to an operational mode. The operational mode would enable the device 16 to receive touch sense control commands from the touch sense control mechanism 12. Alternatively, if the switch 14 is depressed for 5 seconds or more, the device 16's operational logic may equate that to a power off and power on control command.

The touch sense control mechanism 12 would only be operational when the operational logic of the device 16 enables it by being in an operational mode that can be controlled by the touch sense control commands of cursor movement, scrolling functions, or activating or selecting a highlighted item on the display screen. Hence, in the integrated control mechanism 10, the touch sense control mechanism 12 and the electrical switch control mechanism 14 complement each other in their operation and control of the functions of the handheld device 16.

As a simplified illustration of use of the integrated control mechanism 10, in a multi-purpose handheld device such as a cellular phone, a user would press control mechanism 12 to activate the control mechanism 14 to transition the device from a standby mode to an operational mode, displaying various functions on the display screen 18. Then the user, using the control mechanism 12 and using touch sense actions of slide and touch would scroll the items displayed and select the function such as check mail, and further using touch control mechanism 12 would be able to select and review the specific e-mail or text message. When the user is done, he would press control mechanism 12 to activate the electrical switch mechanism 14 to go back to the standby mode of the device 16.

The electrical switch control mechanism 14 may be used for multiple functions in a sequence, when the switch 14 is activated in a sequence. For example, one action may be used to pick-up a phone and another to hang-up to disconnect the phone connection. One action may be to go to game mode, next to music mode and next to home. Such sequence of actions in the control mechanism 14 would be managed in the control logic of the handheld device 16.

As another illustration in that of a remote control application, the user would depress touch control mechanism 12 to power on the hand held device, and would see different options on a display screen of the remote control. Then the user would use the touch control mechanism 12 to scroll and select a function of home theatre and depress the touch sense control mechanism 12 to activate the electrical switch control mechanism 14 to power on that specific home theatre device. When the home theatre device such as a television or a digital recording device needs to be programmed, the user would use the touch control mechanism 12 and these commands would be transmitted to the Home theatre equipment to display and select from the theatre equipment mode choices.

As yet another simplified illustration of use of the integrated control mechanism 10, in a music and camera handheld device, a user would press touch control mechanism 12 to activate control mechanism 14 to transition the device from standby mode to an operational mode, displaying various functions on the display screen 18. Then the user, using the touch control mechanism 12 and using touch sense actions of slide and touch would scroll the items displayed and select the function such as player list or camera mode. The user using touch control mechanism 12 would be able to select and review the details of a player list or camera modes. When the user is done, he would press on the touch control mechanism 12 to activate the electrical switch control mechanism 14 to go back to the standby mode.

A touch screen detection logic may be provided in the touch sense control mechanism 12 that receives touch inputs from the control surface 32 and provides a user interface from the touch sense control mechanism 12 to the handheld device 16 for controlling and navigating the functions of the handheld device. Also, in the electrical switch control mechanism 14, circuits that output switch states to a device 16 control logic enables an integrated control mechanism 10 to be interfaced to the handheld device 16.

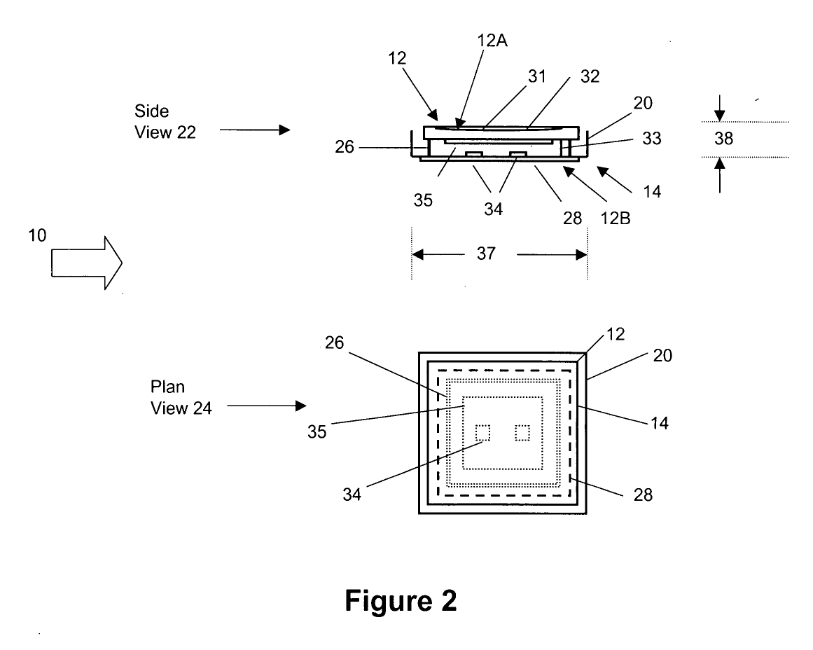

FIG. 2 shows a side view 22 and a plan view 24 of the integrated control mechanism 10. The touch sense control mechanism 12 has a touch sense module 12A with a touch sense surface 32. The touch sense surface 32 may be slight concave surface 31 for ease in operation of the electrical switch 14 underneath.

The touch sense control mechanism 12 also has a touch sense detection logic 12B in a circuit card 28. The touch sense module 12A is interfaced to the detection logic 12B in the circuit card 28 via an interface connector 33.

As illustrated, the electrical switch control mechanism 14 may have multiple electrical contacts 35 and 34, where contacts 34 are positioned on the circuit card 28. The electrical switch has movement resistance means 26. The resistance means 26 to switch movement may take many forms and may include a wound spring, a cantilever spring or a ring made of material such as a suitable form of rubber.

These control mechanisms 12 and 14 are positioned inside a housing socket 20 of the device 16. The touch sense control mechanism 12 sends touch signals to a detection logic 12B on the logic circuit card 28 via the interface connector 33. The detection logic 28 on the logic circuit card 28 processes these signals via processor functions as described later.

With reference to FIG. 2, the electrical switch mechanism 14 that is positioned underneath the touch sense control mechanism 12 may be of a pressure type for activation by a downward pressure of a thumb-tip on the touch sense control mechanism 12. The electrical switch control mechanism 14 is positioned underneath the touch sense control mechanism 12 for activation by pressure action of the thumb on the touch sense control mechanism touch surface 32.

The electrical switch control mechanism 14 is a pressure activated switch mechanism, where the electrical switch is of pressure mechanism activated by pressure on the control surface 32. Such an electro-mechanical switch can take many forms. One from is a pressure switch. There are many types of on/off pressure sensitive switches in the market that may be based on using a spring that may be a cantilever or a wound spring.

The dimension 37 of the integrated control mechanism 10 may be from half an inch to a three quarter of an inch. The height dimension 38 may be from ⅛ to 3/16 inch to accommodate the integrated control mechanism 10 within the thickness profile of the various handheld device applications as illustrated in FIG. 4

The touch sense surface 32 of the module 12A is limited in touch surface size in one of its dimensions to be a maximum of 1.0 inch and the surface area is less than or equal to one square inch.

The touch sense control mechanism 12 has a detection logic 12B. The detection logic 12B has a first processor function (not shown) that receives inputs from the touch sense surface 32 and processes them to identify a touch location on the touch surface 32.

The detection logic 12B may have a second processor function (not shown) that, (i) stores boundary data of multiple touch areas of the control surface 32, (ii) receives touch surface inputs from the first processor function, and (iii) processes them to identify one or more control commands of a touch on a touch area of the surface 32 and a slide between two touch areas of the surface 32 for output from the detection logic 12B to the handheld device 16.

Touch screen technology is prior art. In prior art, the conducting and non-conducting layers that make up the touch screen sensitive surface are placed over a glass substrate that is the display screen of the device. An additional protective layer is placed over the touch sensitive surface layers. Since the underlying display screen must be visible through the touch screen, touch screen layers are designed to transmit light. In the prior art, upward of 90% light is transmitted through the touch screen layers.

However, in the embodiments described here, the touch sense surface may be placed on a suitable substrate that is not a glass surface of a display screen. Alternatively, it may be a glass surface that may be marked with visual markings that identify different touch areas for touch slide movements as well as names of control functions. Since there is not an underlying display screen providing light, such touch screens may be backlit. Backlighting a control is prior art technology.

The module 12A has electrical interfaces 33 on a periphery of the module 12A that enable the module 12A to be directly attached to a receiving interface socket 20 in the device 16.

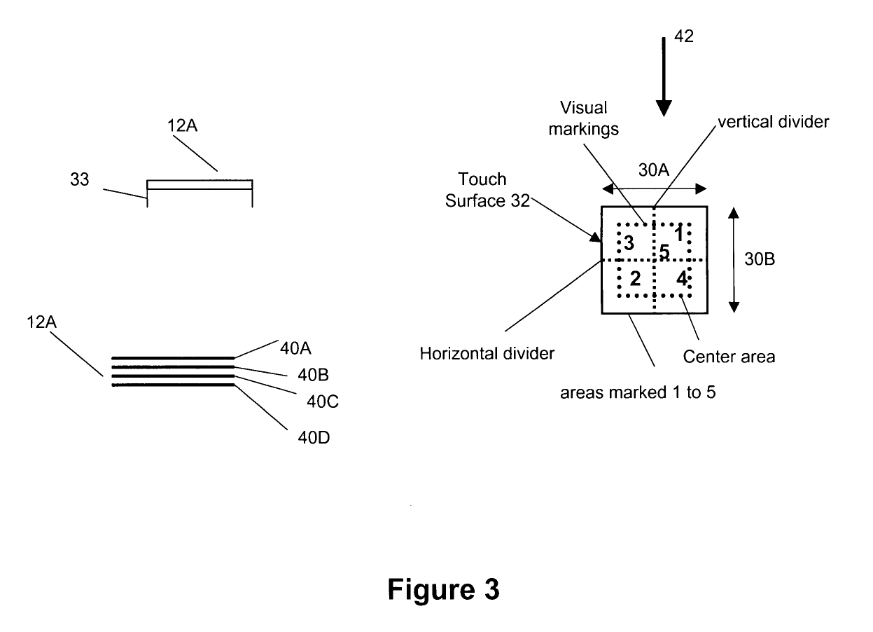

As illustrated with reference to FIG. 3, the integrated control mechanism 10 for handheld electronic devices 16 has a touch sense control module 12A with a capacitive touch sense surface module that includes a substrate, a conducting and a non-conductive layer, and a protective layer. Hence, the touch sense control module 12A has a capacitive touch sense surface with a substrate 40D, a conducting layer 40C, a non-conductive layer 40B, and a protective layer 40A.

The touch screen control surface 32 is partitioned into multiple touch areas 42 for detecting touch inputs. In some applications, there may be at least two touch areas enabling a thumb-tip to slide between these two areas (not shown). In other applications, as illustrated with reference, there may be multiple overlapping touch areas on the control surface to include, a top area, a bottom area, a left area, and a right area, where a sliding touch action on the areas creates a set of navigation control commands, and a center area, where a touch creates functional mode commands for the handheld device 16.

In one of the embodiments, the touch surface 32 is partitioned into a left and a right area. The same area is partitioned into a top and a bottom area that overlaps the left and right areas. These overlapping areas enable a thumb tip slide movement from the left area to the right area and vice versa and from the top area to the bottom area and vice versa for corresponding control functions in the handheld electronic device 16. A quick touch action on the surface in the center is used for controlling the functions of the handheld device 16.

As illustrated in FIG. 3, the touch surface 32 has touch areas, such as five overlapping areas, marked as 1, 2, 3, 4 and 5. Hence, as shown in FIG. 3, the touch surface 32 is partitioned into a left area 3 and a right area 4 divided by a vertical divider and an overlapping top area 1 and a bottom area 2 divided by a horizontal divider. These overlapping areas enable a thumb tip slide movement from the left area 3 to the right area 4 and vice versa and from the top area 1 to the bottom area 2 and vice versa for corresponding cursor movement or scroll control functions in the handheld electronic device 16.

A quick touch in the center area 5 may be used for controlling the functions of the handheld device and a quick double touch in the center area may be used for a mode change control.

The touch surface 32 may be visually partitioned to show the touch areas by lines. The visual partition may also use a combination of lines and/or shading. As a simplified illustration, a vertical divider as a dotted line and a horizontal divider as a dotted line in the middle of the control surface demarcate the overlapping top 1 and bottom 2, and the left 3 and right 4 touch areas. A square dotted line box area 5 on surface identifies the overlapping center touch area.

The touch surface 32 of the module 12A may be sized to be ½×½ inch which may be preferred for small handheld devices 16. A size of ¾×¾ inch may be preferred for larger handheld devices 16. In such a touch screen control surface, the surface may be limited in size 30A×30B to be ½ inch by ½ inch for operation by a thumb tip, and for positioning on a handheld electronic device 16. The size may be a little larger and the size 30A×30B is determined by the physical space available on the handheld device 16.

With reference to FIG. 4, the integrated control mechanism 10 may be used in many handheld devices. These may include, (i) a portable music device 60, (ii) a remote control device for control applications 54 with a transmitting means 54A, (iii) two control surfaces positioned on a game controller 56 with a wired interface 56A, (iv) a multi-purpose computing device to include a personal digital assistant, a wireless communication device, and a direction finding device 52, and (v) a digital camera device 58.

In summary, the embodiments provide an improved user interface using an integrated control mechanism 10 that integrates a touch sense control mechanism 12 on the top and an electrical switch mechanism 14 underneath for use in handheld devices. The embodiments provide an improved user interface using a touch screen control surface for hand held electronic devices that can be used for those devices that currently use touch screen and also for those devices that currently do not use a touch screen display.

While the particular embodiments, as illustrated herein and disclosed in detail is fully capable of obtaining the objective and providing the advantages herein before stated, it is to be understood that they are merely illustrative of the embodiments and that no limitations are intended to the details of construction or design herein shown other than as described in the appended claims.

What is claimed is:

1. A handheld electronic device, comprising:
a. the handheld electronic device has a display screen on a part of the device;
b. an integrated control mechanism, that integrates a touch sense control mechanism on top and an electrical switch control mechanism underneath the touch sense control mechanism, is positioned on the handheld device next to the display screen.

2. The handheld device as in claim 1, further comprising:
the integrated control mechanism is operated by a thumb-tip touch action on surface of the touch sense control mechanism to operate the touch sense control mechanism and by thumb-tip pressure on the same touch sense surface to operate the electrical switch mechanism underneath.

3. The handheld device as in claim 1, further comprising:
the handheld device is used for one of the applications from a group of applications of, (i) a remote control for controlling remote devices via a infrared transmitting means in the handheld device, (ii) a cellular phone, (iii) a multi-purpose device that incorporates multiple features of cell phone, music device and camera, (iii) a music device, (iv) and a digital camera device.

4. The handheld device as in claim 1, further comprising:
a. a touch screen detection logic in the touch sense control mechanism receives touch inputs from the touch sense control surface and provides a user interface from the control mechanism for controlling and navigating the functions of the handheld device;
b. in the electrical switch control mechanism that is operated by a mechanical movement of the switch mechanism, logic that output switch states to a device function control logic, enabling the integrated control mechanism to be interfaced to the handheld device.

5. The handheld device as in claim 1, comprising:
the electrical switch mechanism that is positioned underneath the touch sense control mechanism is a pressure type for activation by a downward pressure of a thumb-tip on the touch sense control mechanism.

6. The handheld device as in claim 1, comprising:
the touch sense control mechanism has a touch sense surface that is limited in surface size in one of its dimensions to be a maximum of 1.0 inch and the surface area is less than or equal to one square inch.

7. The handheld device as in claim 1, further comprising:
the electrical switch mechanism activates a plurality of functional modes of the device from the group of, (i) on/off, (ii) transition to and from a standby mode, (iii) connect and disconnect to a telephone connection, and (iv) transition between major modes of, music, games, personal data and home.

8. A control mechanism for use in a handheld electronic device, comprising:
a. an integrated control mechanism that integrates a touch sense control mechanism on the top and an electrical switch mechanism underneath the touch sense control mechanism;
b. the integrated switch mechanism is operated by a thumb-tip touch action on surface of the touch sense control mechanism to operate the touch sense control mechanism and by thumb-tip pressure on the touch sense surface to operate the electrical switch control mechanism underneath.

9. The control mechanism as in claim 8, comprising:
the integrated control mechanism used in handheld electronic devices from a group of (i) remote control devices (ii) wireless communication devices, (iii) multi-purpose devices, and (iv) gaming devices.

10. The control mechanism as in claim 8, comprising:
the electrical switch mechanism that is positioned underneath the touch sense control mechanism is of a pressure type for activation by a downward pressure of a thumb-tip on the touch sense control mechanism.

11. The control mechanism as in claim 8, comprising:
the touch sense control mechanism has a touch sense surface that is limited in surface size in one of its dimensions to be a maximum of 1.0 inch and the surface area is less than or equal to one square inch.

12. The control mechanism as in claim 8, further comprising:
a. the touch sense control mechanism has touch sense signal outputs that correspond to the touch sense for interface to an operational logic circuit of the handheld device;
b. the electrical switch mechanism has signal outputs that correspond with the electrical switch states for interface to an operational logic circuit of the handheld device.

13. An integrated control mechanism for handheld electronic devices comprising:
a. touch sense control mechanism with a capacitive touch sense surface module that includes a substrate, a conducting and a non-conductive layer, and a protective layer and the module is used in a handheld electronic device for controlling the functions of the device by not placing the module over a display screen of the device;
b. an electrical switch mechanism is positioned underneath the touch sense control device for activation by pressure action of the thumb on the touch surface of the touch sense control mechanism.

14. The mechanism as in claim 13, comprising:
the touch sense module is limited in touch surface size in one of its dimensions to be a maximum of 1.0 inch and the surface area is less than or equal to one square inch.

15. The mechanism as in claim 13, comprising:
the module has electrical interfaces on a periphery of the module that enable the module to be directly attached to a receiving interface socket in the handheld device.

16. The mechanism as in claim 11, comprising:
a first processor function embedded in the touch sense control mechanism that receives inputs from the touch surface and processes them to identify a touch location on the touch surface.

17. The mechanism as in claim 16, comprising:
a second processor function, (i) stores boundary data of multiple touch areas of the control surface (ii) receives touch surface inputs from the first processor function, and (iii) processes them to identify one or more touch control commands on a touch area of the surface and a slide between two touch areas of the surface for output from the module to the handheld device.

18. The mechanism as in claim 13, further comprising:
the electrical switch control mechanism is positioned under the touch sense control mechanism for activation by a downward pressure of a thumb-tip on the touch surface.

19. The mechanism as in claim 13, further comprising:
the electrical switch mechanism activates a plurality of functional modes of the device from the group of, (i) on/off, (ii) transition to and from a standby mode, (iii) connect and disconnect to a telephone connection, and (iv) transition between major modes of, music, games, personal data and home.

20. The mechanism as in claim 13, further comprising:
the electrical switch control mechanism has signal outputs that correspond with the electrical switch states and are in the form of electrical contacts on the integrated control mechanism for interface to an operational logic of the handheld device.
